(19) United States
(12) Patent Application Publication
(10) Pub. No.: US 2019/0066249 A1
(43) Pub. Date: Feb. 28, 2019

(54) RIDE SHARE BEHAVIOR MONITORING

(71) Applicant: GM Global Technology Operations LLC, Detroit, MI (US)

(72) Inventors: Mary E. Decaluwe, Oxford, MI (US); Jim K. Rainbolt, Haslett, MI (US); Spencer W. Chamberlain, Sterling Heights, MI (US); Louise E. Stauffer, Bloomfield Hills, MI (US)

(21) Appl. No.: 15/687,916

(22) Filed: Aug. 28, 2017

(51) Int. Cl. G06Q 50/30; G06Q 30/02

(52) U.S. Cl. CPC G06Q 50/30; G06Q 30/0282

(57) ABSTRACT

Embodiments include methods, systems and computer readable storage medium for rideshare behavior monitoring. The method includes receiving, by a processor, feedback from a next rider. The method further includes receiving, by the processor, feedback from a rideshare service transport. The method further includes generating, by the processor, a rideshare behavior score for a previous occupant of the rideshare service transport based on the feedback from the next rider and the feedback from the rideshare service transport. The method further includes correlating, by the processor, the rideshare behavior score with a plurality of possible actions. The method further includes selecting, by the processor, one or more possible actions based on the correlation. The method also includes implementing, by the processor, the one or more possible actions.

### INTRODUCTION

The subject disclosure relates to rideshare services, and more specifically to monitoring user behavior in a ride share system.

Real-time ridesharing (also called dynamic, on-demand or instant ridesharing) is an automated service that matches drivers and users requesting one-way ridesharing services on very short notice. Real-time ridesharing (ridesharing) typically employs some form of navigation services/devices, applications for drivers to receive notifications for passenger pickup and applications for users to request ridesharing services. Ridesharing functionality in light of new technologies, for example, autonomous vehicles, are increasingly being considered.

Autonomous vehicles are automobiles that have the ability to operate and navigate without human input. Autonomous vehicles use sensors, such as radar, LIDAR, global positioning systems, and computer vision, to detect the vehicle's surroundings. Advanced computer control systems interpret the sensory input information to identify appropriate navigation paths, as well as obstacles and relevant signage. Some autonomous vehicles update map information in real time to remain aware of the autonomous vehicle's location even if conditions change or the vehicle enters an uncharted environment. Autonomous vehicles increasingly communicate with remote computer systems via wireless network connections and with one another using dedicated short-range communications (DSRC).

Accordingly, it is desirable to provide a system that receives feedback from both a subsequent (next) rider and a vehicle, in which a ride sharing service has provided to a previous occupant, as inputs to a vehicle sharing point/demerit matrix which awards points to recognize and encourage positive ridership behavior and assigns demerits to recognize and discourage negative ridership behavior.

### SUMMARY

In one exemplary embodiment, a method for rideshare behavior monitoring is disclosed. The method includes receiving, by a processor, feedback from a next rider. The method further includes receiving, by the processor, feedback from a rideshare service transport. The method further includes generating, by the processor, a rideshare behavior score for a previous occupant of the rideshare service transport based on the feedback from the next rider and the feedback from the rideshare service transport. The method further includes correlating, by the processor, the rideshare behavior score with a plurality of possible actions. The method further includes selecting, by the processor, one or more possible actions based on the correlation. The method also includes implementing, by the processor, the one or more possible actions.

In addition to one or more of the features described herein, one or more actions of the described method can additionally include vehicle mitigation which can include cleaning the rideshare service transport, repairing the rideshare service transport or maintenance for the rideshare service transports. Another action of the one or more possible actions is providing incentives to a rider for good behavior and providing dis-incentives to a rider for poor behavior. Feedback from the next rider can be associated with at least one of vehicle cleanliness, odors, rider section damage, and solicitations left by a previous occupant. Feedback from the rideshare service transport can be associated with at least one of: vehicle cleanliness; smoking; rider section damage; extra occupants; pets and/or (messes, allergens or damage related to pets) and unsafe behavior by a previous occupant. In addition, the rideshare transport can be an autonomous vehicle.

In another exemplary embodiment, a system for rideshare behavior monitoring is disclosed herein. The system includes a memory and processor in which the processor receives feedback from a next rider. The processor further receive feedback from a rideshare service transport. The processor further generates a rideshare behavior score for a previous occupant of the rideshare service transport based on the feedback from the next rider and the feedback from the rideshare service transport. The processor further correlates the rideshare behavior score with a plurality of possible actions. The processor further selects one or more possible actions based on the correlation and implements the one or more possible actions.

In yet another exemplary embodiment a computer readable storage medium for rideshare behavior monitoring is disclosed herein. The computer readable storage medium includes receiving feedback from a next rider. The computer readable storage medium further includes receiving feedback from a rideshare service transport. The computer readable storage medium further includes generating a rideshare behavior score for a previous occupant of the rideshare service transport based on the feedback from the next rider and the feedback from the rideshare service transport. The computer readable storage medium further includes correlating the rideshare behavior score with a plurality of possible actions. The computer readable storage medium further includes selecting one or more possible actions based on the correlation and implementing the one or more possible actions.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 depicts a rideshare behavior and award/mitigation matrix according to one or more embodiments; and

FIG. 4 is a flow diagram of a method for rideshare behavior monitoring according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

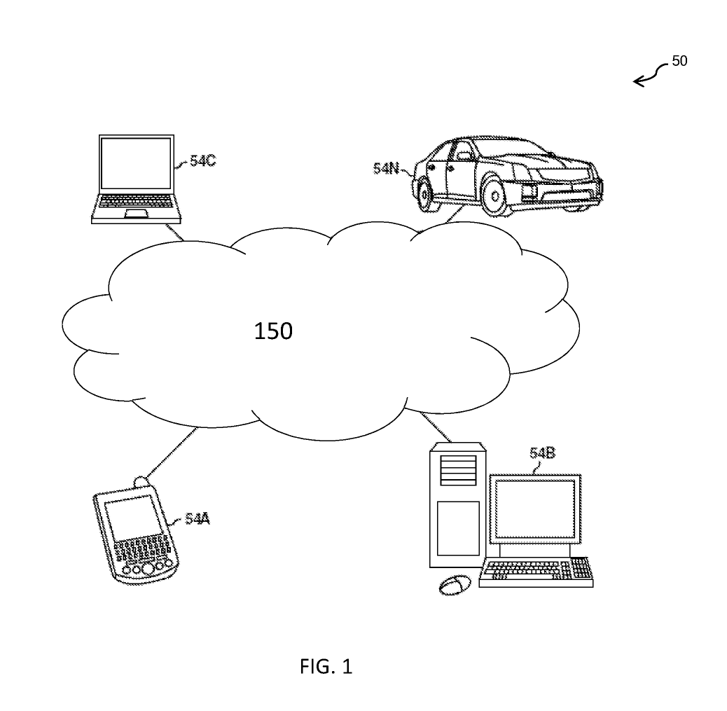

In accordance with an exemplary embodiment, FIG. 1 illustrates a computing environment 50 associated with a ride share behavior monitoring system. As shown, computing environment 50 comprises one or more computing devices, for example, personal digital assistant (PDA) or cellular telephone (mobile device) 54A, server 54B, computer 54C, and/or automobile onboard computer system 54N, which are connected via network 150. The one or more computing devices may communicate with one another using network 150.

Network 150 can be, for example, a local area network (LAN), a wide area network (WAN), such as the Internet, a dedicated short range communications network, or any combination thereof, and may include wired, wireless, fiber optic, or any other connection. Network 150 can be any combination of connections and protocols that will support communication between mobile device 54A, server 54B, computer 54C, and/or automobile onboard computer system 54N, respectively.

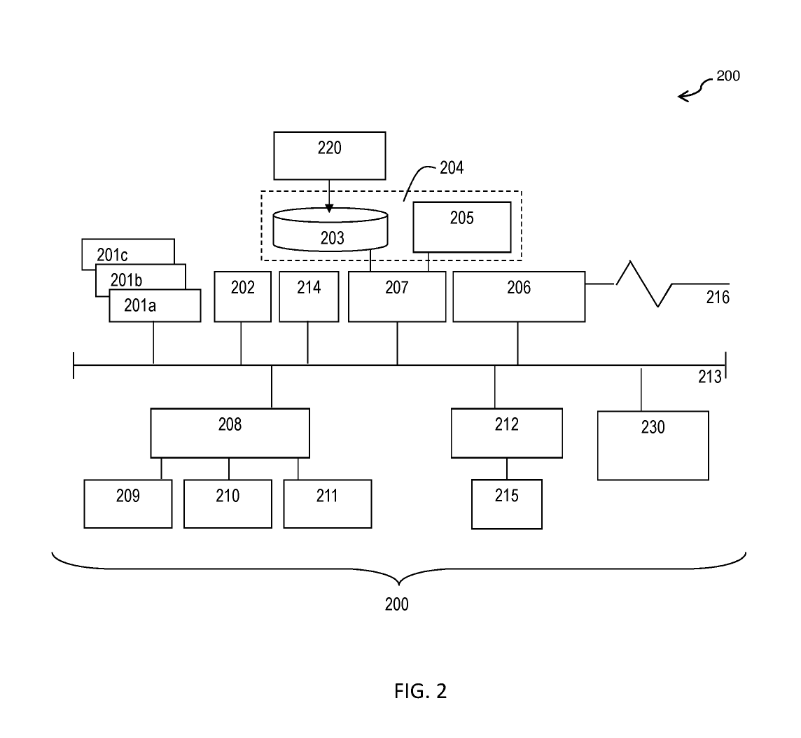

In accordance with an exemplary embodiment, FIG. 2 illustrates a processing system 200 for implementing the teachings herein. The processing system 200 can form at least a portion of the one or more computing devices, such as mobile device 54A, server 54B, computer 54C, and/or automobile onboard computer system 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. A network adapter 206 interconnects bus 213 with an outside network 216, via network 150, enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

The one or more computing devices may further include a transmitter and receiver (not shown), to transmit and receive information. The signals sent and received may include data, communication, and/or other propagated signals. Further, it should be noted that the functions of transmitter and receiver could be combined into a signal transceiver.

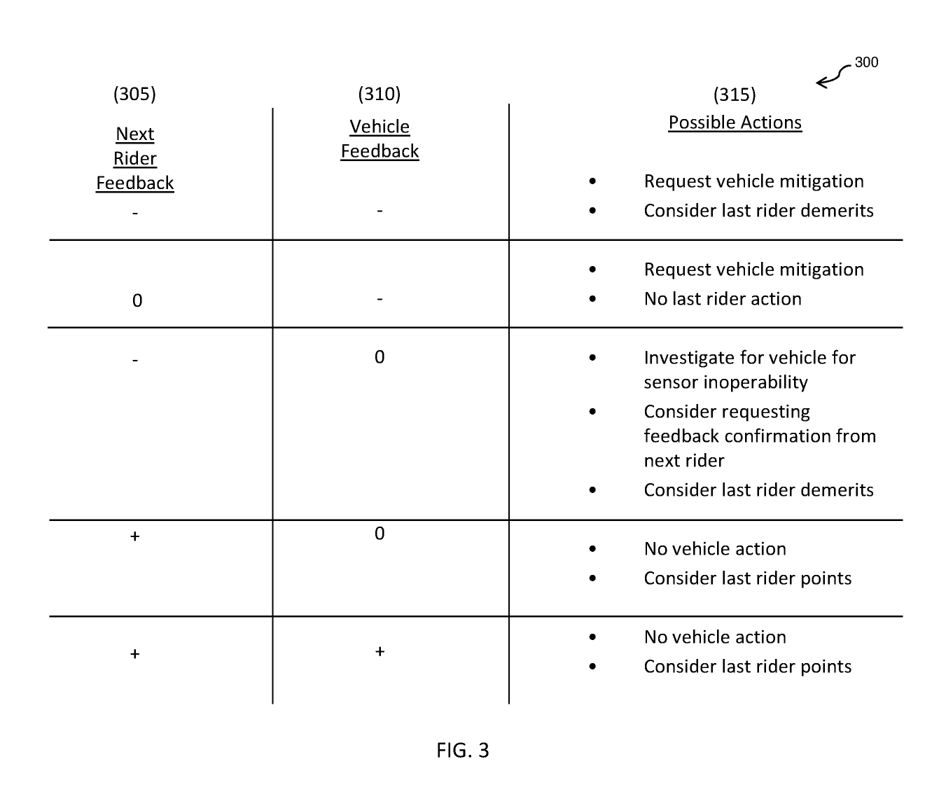

In accordance with an exemplary embodiment, FIG. 3 depicts a rideshare behavior and award/mitigation matrix 300. When using the rideshare behavior and award/mitigation matrix 300, a server, for example, server 54B can receive a plurality of inputs.

An input received by server 54B can be an input (305) from a next rider. The next rider can be a rider obtaining rideshare services in an associated rideshare service transport, for example an automobile associated with automobile onboard computer system 54N or any other form of transportation conducive to providing ridesharing services. The next rider can provide feedback on a previous occupant of the rideshare service transport to server 54B across network 150 using for, example, an application stored on mobile device 54A or an onboard application associated within the rideshare service transport (not shown). The feedback provided by the next rider can be related to a variety of aspects. For example, the next rider can indicate, automobile cleanliness, odors within the automobile, rider section damage, solicitations left in the rider section, or the like. The next rider feedback can be converted by the server 54B to a rideshare behavior score (next rider) for use with the rideshare behavior and award/mitigation matrix 300, for example, positive (+), negative (−), or neutral (0), depending on the feedback provided by the next rider.

Another input received by server 54B can be an input (310) from the rideshare service transport. Input 310 can be provided by a rideshare service driver associated with the rideshare service transport, a third-party tasked with checking and/or cleaning the rideshare service transport or the rideshare service transport itself in autonomous vehicle operations. Rideshare service transport feedback can be related to automobile cleanliness, smoking within the automobile, rider section damage, unsafe rider behavior during transit, additional riders, pets in the automobile and/or messes, allergens or damage related to pets, being at a pickup location on-time or the like. Rideshare service transport feedback can be provided to server 54B using the automobile onboard computer system 54N and network 150. For autonomous vehicle operations, feedback can be provided using one or more on-board sensors. For example, the one or more sensors can be visual sensors used to compare images of a rider section before and after occupant use; seat sensors used to determine one or more weight differentials within the rider section; electromagnetic field sensors (humidity detector) used to determine whether liquids have spilled in the rider section; odor sensors; or the like. The rideshare service transport feedback can be converted by the server 54B to a rideshare behavior score (Vehicle) for use with the rideshare behavior and award/mitigation matrix 300, for example, positive (+), negative (−), or neutral (0), depending on the feedback provided by the rideshare service transport.

When accessing the rideshare behavior and award/mitigation matrix 300, the server 54B can use the rideshare behavior score input 305 from the next rider and the rideshare behavior score input 310 from the rideshare service transport to correlate possible actions 315 to implement in relation to the previous occupant and/or the rideshare service transport. For example, as illustrated in FIG. 3, if the next rider feedback generates a negative rideshare behavior score and the rideshare service transport feedback generates a negative rideshare behavior score, the server 54B can select actions within the rideshare behavior and award/mitigation matrix 300 associated with negative feedback from both the next rider and the rideshare service transport from the possible actions 315. Accordingly, the server 54B can output a request for vehicle mitigation for the rideshare service transport and/or deduct points from the rider score associated with the previous occupant. The vehicle mitigation can be addressed by a party associated with computer 54C that can be contacted by the server 54B over network 150. Vehicle mitigation can entail a variety of actions (repairs, cleaning and maintenance depending on issues gleaned from the next rider feedback and the rideshare service transport feedback, as well as a severity level associated with the issues.)

If the next rider feedback generates a neutral rideshare behavior score and the rideshare service transport feedback generates a negative rideshare behavior score, the server 54B can select actions within the rideshare behavior and award/mitigation matrix 300 associated with neutral feedback from the next rider and negative feedback from the rideshare service transport from the possible actions 315. The server 54B can request vehicle mitigation but would not deduct points for the rider score of the previous occupant.

If the next rider feedback generates a negative rideshare behavior score and the rideshare service transport feedback generates a neutral rideshare behavior score, the server 54B can select actions within the rideshare behavior and award/mitigation matrix 300 associated with negative feedback from the next rider and neutral feedback from the rideshare service transport from the possible actions 315. The server 54B can contact the rideshare service transport or an operator of the rideshare service operator to request an inspection of one or more sensors operating on the rideshare service transport. The server 54B could also contact the next rider and request confirmation of the negative feedback provided by the previous next rider. The server 54B would or would not deduct points for the rider score of the previous occupant depending on the confirmation information provided.

If the next rider feedback generates a positive rideshare behavior score and the rideshare service transport feedback generates a neutral rideshare behavior score, the server 54B can select actions within the rideshare behavior and award/mitigation matrix 300 associated with positive feedback from the next rider and neutral feedback from the rideshare service transport from the possible actions 315. The server 54B can indicate that no vehicle mitigation action is needed, and the server 54B can add points to the rider score of the previous occupant.

If the next rider feedback generates a positive rideshare behavior score and the rideshare service transport feedback generates a positive rideshare behavior score, the server 54B can select actions within the rideshare behavior and award/mitigation matrix 300 associated with positive feedback from the next rider and positive feedback from the rideshare service transport from the possible actions 315. The server 54B can indicate that no vehicle mitigation action is needed, and the server 54B can add points to the rider score of the previous occupant.

If the next rider feedback generates a neutral rideshare behavior score and the rideshare service transport feedback generates a neutral rideshare behavior score, the server 54B can indicate that no action is needed (not shown). The rider score of the previous occupant would not be changed.

If the next rider feedback generates a negative rideshare behavior score and the rideshare service transport feedback generates a positive rideshare behavior score (not shown), the server 54B can select actions within the rideshare behavior and award/mitigation matrix 300 associated with negative feedback from the next rider and positive feedback from the rideshare service transport from the possible actions 315. The server 54B can request a verification of positive output for the one or more sensors operating on the rideshare service transport by the rideshare service transport or an operator of the rideshare service operator. The server 54B can requests vehicle mitigation, if needed and add or deduct points, or make no changes to the rider score of the previous occupant based on the verification results sent by the rideshare service transport or the operator of the rideshare service operator.

If the next rider feedback generates a positive rideshare behavior score and the rideshare service transport feedback generates a negative rideshare behavior score (not shown), the server 54B can select actions within the rideshare behavior and award/mitigation matrix 300 associated with positive feedback from the next rider and negative feedback from the rideshare service transport from the possible actions 315. The server 54B can request a verification of negative output for the one or more sensors operating on the rideshare service transport by the rideshare service transport or an operator of the rideshare service operator. The server 54B requests vehicle mitigation, if needed and can add or deduct points, or make no changes to the rider score of the previous occupant based on the verification results sent by the rideshare service transport or the operator of the rideshare service operator.

Accordingly, the server 54B can generate/update a rider score. The rider score can be implemented as a point system associated with the behavior of the previous occupant of the rideshare service transport. The server 54B can add points for good behavior when utilizing ridesharing services and deduct point for poor behavior when utilizing ridesharing services. Depending on a rider score, the rider could receive benefits/incentives or dis-incentives from server 54B. The server 54B can also store a number of instances and offense types when the previous occupant has points deducted.

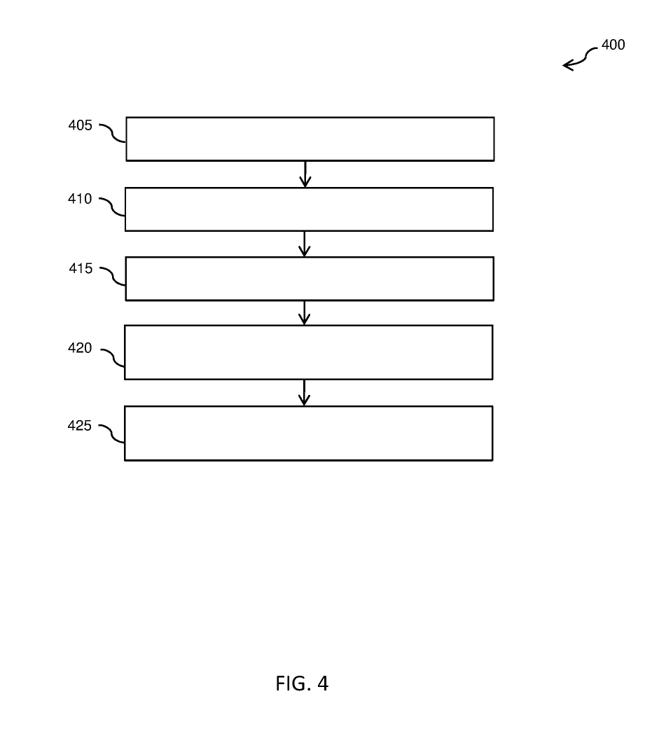

In accordance with an exemplary embodiment, FIG. 4 depicts a flow diagram of a method for rideshare behavior monitoring 400. At block 405, a next rider can provide feedback to server 54B related to a state of a rider section of a rideshare service transport left by a previous occupant. At block 410, the rideshare service transport also provides feedback to server 54B related to a state of a rider section of the rideshare service transport left by the previous occupant. At block 415, the server 54B can generate a rideshare behavior score based on the next rider feedback and a rideshare behavior score based on feedback provided by the rideshare service transport. At block 420, the server 45B can correlate the rideshare behavior score determined from the next rider feedback and the rideshare behavior score determined from the rideshare service transport with a list of possible actions using, for example, a rideshare behavior and award/mitigation matrix 300. At block 425, the server 54B can select an implementation of one or more possible actions associated with determined correlation, for example, the server 54B can implement vehicle mitigation, add or deduct points to a rider score of a previous occupant, and provide incentives to riders exhibiting good behavior depending on the correlation of rider behavior scores with the list of possible actions.

Incentives that can be provided to riders for good behavior can include receiving higher priority to ride requests, having access to broader vehicle choices, discounts with partner companies, free rides, promotional material or the like. The server 54 can also use feedback with the system to identify conduct associated with good behavior to determine further incentives to provide to riders to foster good behavior.

The server 54B can also associate offenses with previous occupants when points are deducted. The server 54B can provide dis-incentives for poor rider behavior. For example, the server can limit vehicle choices or lowering priority for ride requests.

Accordingly, the embodiments disclosed herein a system that monitors rider behavior when using a ride share service through feedback provided by a subsequent (next) rider and from the vehicle providing for the ride sharing service. The system can be used to influence better rider behavior by encouraging positive behavior through incentives and discouraging poor rider behavior through dis-incentives.

Technical effects and benefits of the disclosed embodiments include, but are not limited to providing an incentive to riders to keep vehicles clean/operational using incentives, which improves vehicle uptime thereby improving revenue per vehicle in a ride share service and a reduction of vehicle maintenance.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for rideshare behavior monitoring, the method comprising:
receiving, by a processor, feedback from a next rider;
receiving, by the processor, feedback from a rideshare service transport;
generating, by the processor, a rideshare behavior score for a previous occupant of the rideshare service transport based on the feedback from the next rider and the feedback from the rideshare service transport;
correlating, by the processor, the rideshare behavior score with a plurality of possible actions;
selecting, by the processor, one or more possible actions based on the correlation; and
implementing, by the processor, the one or more possible actions.

2. The method of claim 1, wherein an action of the one or more possible actions is vehicle mitigation.

3. The method of claim 2, wherein vehicle mitigation can include cleaning the rideshare service transport, repairing the rideshare service transport or maintenance for the rideshare service transports.

4. The method of claim 1, wherein an action of the one or more possible actions is providing incentives to a rider for good behavior.

5. The method of claim 1, wherein an action of the one or more possible actions is providing dis-incentives to a rider for poor behavior.

6. The method of claim 1, wherein the feedback from the next rider is associated with at least one of vehicle cleanliness, odors, rider section damage, and solicitations left by a previous occupant.

7. The method of claim 1, wherein the feedback from the rideshare service transport is associated with at least one of: vehicle cleanliness; smoking; rider section damage; extra occupants; pets and/or (messes, allergens or damage related to pets) and unsafe behavior by a previous occupant.

8. The method of claim 1, wherein the rideshare service transport is an autonomous vehicle.

9. A system for rideshare behavior monitoring, the system comprising:
a memory; and
a processor coupled to the memory, wherein the processor:
receives feedback from a next rider;
receives feedback from a rideshare service transport;
generates a rideshare behavior score for a previous occupant of the rideshare service transport based on the feedback from the next rider and the feedback from the rideshare service transport;
correlates the rideshare behavior score with a plurality of possible actions;
selects one or more possible actions based on the correlation; and
implements the one or more possible actions.

10. The system of claim 9, wherein an action of the one or more possible actions is vehicle mitigation.

11. The system of claim 10, wherein vehicle mitigation can include cleaning the rideshare service transport, repairing the rideshare service transport or maintenance for the rideshare service transports.

12. The system of claim 9, wherein an action of the one or more possible actions is providing incentives to a rider for good behavior.

13. The system of claim 9, wherein an action of the one or more possible actions is providing dis-incentives to a rider for poor behavior.

14. The system of claim 9, wherein the feedback from the next rider is associated with at least one of vehicle cleanliness, odors, rider section damage, and solicitations left by a previous occupant.

15. The system of claim 9, wherein the feedback from the rideshare service transport is associated with at least one of: vehicle cleanliness; smoking; rider section damage; extra occupants; pets and/or (messes, allergens or damage related to pets) and unsafe behavior by a previous occupant.

16. The system of claim 9, wherein the rideshare service transport is an autonomous vehicle.

17. A non-transitory computer readable storage medium having program instructions embodied therewith, the program instructions readable by a processor to cause the processor to perform a method for rideshare behavior monitoring comprising:
receiving feedback from a next rider;
receiving feedback from a rideshare service transport;
generating a rideshare behavior score for a previous occupant of the rideshare service transport based on the feedback from the next rider and the feedback from the rideshare service transport;
correlating the rideshare behavior score with a plurality of possible actions;
selecting one or more possible actions based on the correlation; and
implementing the one or more possible actions.

18. The computer readable storage medium of claim 17, wherein an action of the one or more possible actions is vehicle mitigation.

19. The computer readable storage medium of claim 17, wherein an action of the one or more possible actions is providing incentives to a rider for good behavior.

20. The computer readable storage medium of claim 17, wherein the rideshare service transport is an autonomous vehicle.
